(19) United States
(12) Patent Application Publication
(10) Pub. No.: US 2026/0244531 A1
(43) Pub. Date: Aug. 20, 2026

(54) DETERMINATION OF ERRORS AS LINK-DRIVEN OR DIE-DRIVEN ERRORS

(71) Applicant: Micron Technology, Inc., Boise, ID (US)

(72) Inventors: Navid Lashkarian, Pleasanton, CA (US); Frank F. Ross, Boise, ID (US); Scott E. Schaefer, Boise, ID (US); Anthony D. Veches, Boise, ID (US); Randall J. Rooney, Boise, ID (US)

(21) Appl. No.: 19/536,053

(22) Filed: Feb. 10, 2026

Related U.S. Application Data
(60) Provisional application No. 63/759,991, filed on Feb. 18, 2025.

(51) Int. Cl. G06F 11/10

(52) U.S. Cl. CPC G06F 11/1068; G06F 11/1048; G06F 11/1076

(57) ABSTRACT

Methods, systems, and devices for determination of errors as link-driven or die-driven errors are described. Generation of redundancy information and parity information for data protection may be split across an interface between a memory system and a host system to improve error detection. The memory system may receive, from the host system via an interface, data and redundancy information associated with the data. The memory system may use the redundancy information to check for errors caused by transfer of the data via the interface. The memory system may request a retransmission or perform an error correction if an error is detected. After the errors in the data due to the interface transmission are corrected, the memory system may generate parity information associated with the data and write the data, the parity information, and the redundancy information to one or more memory devices of the memory system.

### CROSS REFERENCE

The present Application for Patent claims priority to U.S. Patent Application No. 63/759,991 by Lashkarian et al., entitled “DETERMINATION OF ERRORS AS LINK-DRIVEN OR DIE-DRIVEN ERRORS,” filed February 18, 2025, which is assigned to the assignee hereof, and which is expressly incorporated by reference in its entirety herein.

### TECHNICAL FIELD

The following relates to one or more systems for memory, including determination of errors as link-driven or die-driven errors.

### BACKGROUND

Memory devices are used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored by the memory cell. To store information, a memory device may write (e.g., program, set, assign) states to the memory cells. To access stored information, a memory device may read (e.g., sense, detect, retrieve, determine) states from the memory cells.

### BRIEF DESCRIPTION OF THE DRAWINGS

FIG. 1 shows an example of a system that supports determination of errors as link-driven or die-driven errors in accordance with examples as disclosed herein.

FIG. 2 shows an example of a system that supports determination of errors as link-driven or die-driven errors in accordance with examples as disclosed herein.

FIG. 3 shows an example of a flow diagram that supports determination of errors as link-driven or die-driven errors in accordance with examples as disclosed herein.

FIG. 4 shows a block diagram of a memory system that supports determination of errors as link-driven or die-driven errors in accordance with examples as disclosed herein.

FIG. 5 shows a flowchart illustrating a method or methods that support determination of errors as link-driven or die-driven errors in accordance with examples as disclosed herein.

### DETAILED DESCRIPTION

Some memory systems may perform error check operations to detect or otherwise identify errors that occur in data stored to one or more memory devices of the memory system. For example, the memory system may store redundancy information (e.g., cyclic redundancy check (CRC) information, error detection code (EDC), or some other type of redundancy) and parity information associated with the data (e.g., error correction code (ECC) information). In some cases, the redundancy information and the parity information may be used for error checking and error correction by one entity. For example, the host system may use the redundancy information to detect whether the data incurred any errors and to identify which memory device of the one or more memory devices within the memory system is associated with the detected errors, and the host system may use the parity information to determine which bit(s) within the identified memory device include the errors. The host system may thereby detect the one or more errors and perform error correction accordingly. In some examples, the memory system may perform the error correction and detection. However, if the redundancy information and parity information are both used for detection and correction of errors before or after the data is transmitted via an interface between the memory system and the host system, the error check operation may not account for any errors that occurred due to the transmission, which may be referred to as link-driven errors in some examples herein.

Techniques, systems, and devices described herein provide for separating the generation of redundancy information and the generation of parity information for data protection. For example, the separation of the redundancy generation and the parity generation may provide for the memory system and the host system to use the redundancy information as a check for any errors that may occur via the interface (e.g., link-driven errors), and to use the redundancy information and the parity information as a check for any errors that may occur due to storage of the data within the memory system (e.g., die-driven errors). The detection of link-driven versus die-driven errors may improve reliability of error detection data communication between the memory system and the host system.

The host system may, for example, transmit data and redundancy information associated with the data to the memory system during a write operation. The memory system may perform an error check operation on the data using the redundancy information to check for errors caused by transfer of the data via the interface. The memory system may perform error correction if an error is detected. Error correction may be performed by transmitting a request for a retransmission of the data, using the redundancy information to correct the error(s) in the data, one or more other types of error correction operations, or any combination thereof. Once the data is received without errors (e.g., during the initial transmission or a retransmission), the errors in the data are corrected by the memory system, or both, the memory system may generate parity information associated with the data. The memory system may write the data, the parity information, and the redundancy information to one or more memory devices of the memory system. During a read operation, the memory system may retrieve the data, the parity information, and the redundancy information, and may use the parity and redundancy information to perform another error check and correction operation associated with die-driven errors. The memory system may send the data and additional redundancy information associated with the data to the host system. The host system may use the redundancy information to determine whether any further errors were incurred via the interface.

In addition to applicability in memory systems described herein, techniques for determination of errors as link-driven or die-driven errors may be generally implemented to improve security and/or authentication features of various electronic devices and systems. As the use of electronic devices for handling private, user, or other sensitive information has become even more widespread, electronic devices and systems have become the target of increasingly frequent and sophisticated attacks. Further, unauthorized access or modification of data in security-critical devices such as vehicles, healthcare devices, and others may be especially concerning. Implementing the techniques described herein may improve the security of electronic devices and systems by improving detection of errors that may occur during transfer of data via an interface, and may prevent or mitigate unauthorized access to data or other information, improve data reliability and accuracy, and may reduce latency and security of communications due to a reduced quantity of uncorrected errors within data, among other benefits.

Features of the disclosure are illustrated and described in the context of systems and architectures. Features of the disclosure are further illustrated and described in the context of a flow diagram and flowcharts.

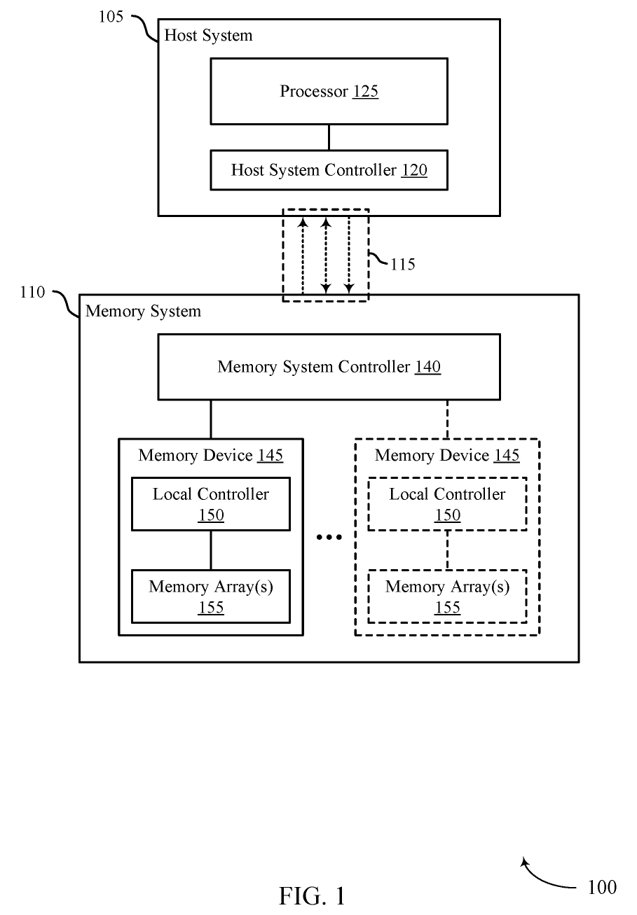

FIG. 1 shows an example of a system 100 that supports determination of errors as link-driven or die-driven errors in accordance with examples as disclosed herein. The system 100 may include portions of an electronic device, such as a computing device, a mobile computing device, a wireless communications device, a graphics processing device, a vehicle, a smartphone, a wearable device, an internet-connected device, a vehicle controller, a system on a chip (SoC), or other stationary or portable electronic system, among other examples. The system 100 includes a host system 105, a memory system 110, and one or more channels 115 coupling the host system 105 with the memory system 110 (e.g., to support a communicative coupling). The system 100 may include any quantity of one or more memory systems 110 coupled with the host system 105.

A host system 105 may include one or more components (e.g., circuitry, processing circuitry, application processing circuitry, one or more processing components) that use memory to execute processes (e.g., applications, functions, computations), any one or more of which may be referred to as or be included in a processor 125 (e.g., an application processor). A processor 125 may include at least one of one or more processing elements that may be co-located or distributed, including a general-purpose processor, a digital signal processor (DSP), an application-specific integrated circuit (ASIC), a field-programmable gate array (FPGA) or other programmable logic device, a controller, discrete gate or transistor logic, one or more discrete hardware components, or a combination thereof. A processor 125 may be an example of a central processing unit (CPU), a graphics processing unit (GPU), a general-purpose GPU (GPGPU), or an SoC or a component thereof, among other examples.

A host system 105 may also include at least one of one or more components (e.g., circuitry, logic, instructions) that implement the functions of an external memory controller (e.g., a host system memory controller), which may be referred to as or be included in a host system controller 120. For example, a host system controller 120 may issue commands or other signaling for operating a memory system 110, such as write commands, read commands, configuration signaling or other operational signaling. In some examples, a host system controller 120, or associated functions described herein, may be implemented by or be part of a processor 125. For example, a host system controller 120 may be hardware, instructions (e.g., software, firmware), or a combination thereof implemented by a processor 125 or other component of a host system 105. In various examples, a host system 105 or a host system controller 120 may be referred to as a host.

A memory system 110 provides physical memory locations (e.g., addresses) that may be used or referenced by the system 100. A memory system 110 may include a memory system controller 140 and one or more memory devices 145 (e.g., memory packages, memory dies, portions of a memory die) operable to store data. A memory system 110 may be configurable for operations with different types of host systems 105, and may respond to commands from the host system 105 (e.g., from a host system controller 120). For example, a memory system 110 (e.g., a memory system controller 140) may receive a write command indicating that the memory system 110 is to store data received from a host system 105, or receive a read command indicating that the memory system 110 is to provide data stored in a memory device 145 to a host system 105, or receive a refresh command indicating that the memory system 110 is to refresh data stored in a memory device 145, among other types of commands and operations.

A memory system controller 140 may include at least one of one or more components (e.g., circuitry, logic, instructions) operable to control operations of a memory system 110. A memory system controller 140 may include hardware or instructions that support the memory system 110 performing various operations, and may be operable to receive, transmit, or respond to commands, data, or control information related to operations of the memory system 110. A memory system controller 140 may be operable to communicate with one or more of a host system controller 120, one or more memory devices 145, or a processor 125. In some examples, a memory system controller 140 may control operations of the memory system 110 in cooperation with a host system controller 120, a local controller 150 of a memory device 145, or any combination thereof. Although the example of memory system controller 140 is illustrated as a separate component of the memory system 110, in some examples, aspects of the functionality of the memory system 110 may be implemented by a processor 125, a host system controller 120, at least one of one or more local controllers 150, or any combination thereof.

Each memory device 145 may include a local controller 150 (e.g., a logic controller, an interface controller, one or more processors) and one or more memory arrays 155. A memory array 155 may be a collection of memory cells (e.g., a two-dimensional array, a three-dimensional array, an array of one or more semiconductor components), with each memory cell being operable to store data (e.g., as one or more stored bits). Each memory array 155 may include memory cells of various architectures, such as random access memory (RAM) cells, dynamic RAM (DRAM) cells, synchronous dynamic RAM (SDRAM) cells, static RAM (SRAM) cells, ferroelectric RAM (FeRAM) cells, magnetic RAM (MRAM) cells, resistive RAM (RRAM) cells, phase change memory (PCM) cells, chalcogenide memory cells, not-or (NOR) memory cells, and not-and (NAND) memory cells, or any combination thereof.

A local controller 150 may include at least one of one or more components (e.g., circuitry, logic, instructions) operable to control operations of a memory device 145. In some examples, a local controller 150 may be operable to communicate (e.g., receive or transmit data or commands or both) with a memory system controller 140. In some examples, a memory system 110 may not include a memory system controller 140, and a local controller 150 or a host system controller 120 may perform functions of a memory system controller 140 described herein. In some examples, a local controller 150, or a memory system controller 140, or both may include decoding components operable for accessing addresses of a memory array 155, sense components for sensing states of memory cells of a memory array 155, write components for writing states to memory cells of a memory array 155, or various other components operable for supporting described operations of a memory system 110.

A host system 105 (e.g., a host system controller 120) and a memory system 110 (e.g., a memory system controller 140) may communicate information (e.g., data, commands, control information, configuration information, timing information) using one or more channels 115. Each channel 115 may be an example of a transmission medium that carries information, and each channel 115 may include one or more signal paths (e.g., a transmission medium, an electrical conductor, a conductive path) between terminals (e.g., nodes, pins, contacts) associated with the components of the system 100. A terminal may be an example of a conductive input or output point of a device of the system 100, and a terminal may be operable as part of a channel 115. In some implementations, at least the channels 115 between a host system 105 and a memory system 110 may include or be referred to as a host interface (e.g., a physical host interface). To support communications over channels 115, a host system 105 (e.g., a host system controller 120) and a memory system 110 (e.g., a memory system controller 140) may include receivers (e.g., latches) for receiving signals, transmitters (e.g., drivers) for transmitting signals, decoders for decoding or demodulating received signals, or encoders for encoding or modulating signals to be transmitted, among other components that support signaling over channels 115, which may be included in a respective interface portion of the respective system.

A channel 115 may be dedicated to communicating one or more types of information, and channels 115 may include unidirectional channels, bidirectional channels, or both. For example, the channels 115 may include one or more command/address channels, one or more clock signal channels, one or more data channels, among other channels or combinations thereof. In some examples, a channel 115 may be configured to provide power from one system to another (e.g., from the host system 105 to the memory system 110, in accordance with a regulated voltage). In some examples, at least a subset of channels 115 may be configured in accordance with a protocol (e.g., a logical protocol, a communications protocol, an operational protocol, an industry standard), which may support configured operations of and interactions between a host system 105 and a memory system 110.

A command/address channel (e.g., a CA channel) may be operable to communicate commands between the host system 105 and the memory system 110, including control information associated with the commands (e.g., address information, configuration information). Commands carried by a command/address channel may include a write command with an address for data to be written to the memory system 110 or a read command with an address of data to be read from the memory system 110.

A clock signal channel may be operable to communicate one or more clock signals between the host system 105 and the memory system 110. Clock signals may oscillate between a high state and a low state, and may support coordination (e.g., in time) between operations of the host system 105 and the memory system 110. In some examples, a clock signal may provide a timing reference for operations of the memory system 110. A clock signal may be referred to as a control clock signal, a command clock signal, or a system clock signal. A system clock signal may be generated by a system clock, which may include one or more hardware components (e.g., oscillators, crystals, logic gates, transistors).

A data channel (e.g., a DQ channel) may be operable to communicate (e.g., bidirectionally) information (e.g., data, control information) between the host system 105 and the memory system 110. For example, a data channel may communicate information from the host system 105 to be written to the memory system 110, or information read from the memory system 110 to the host system 105. In some examples, channels 115 may include one or more error detection code (EDC) channels. An EDC channel may be operable to communicate error detection signals, such as checksums or parity bits, which may accompany information conveyed over a data channel.

Signaling may be communicated over the channels 115 using single data rate (SDR) signaling or double data rate (DDR) signaling, among other rates (e.g., relative to a clock signal). In SDR signaling, one modulation symbol (e.g., signal level) of a signal may be registered for each clock cycle (e.g., on a rising edge or a falling edge of a clock signal). In DDR signaling, two modulation symbols of a signal may be registered for each clock cycle (e.g., on both a rising edge and a falling edge of a clock signal).

Signals communicated over the channels 115 may be modulated using various modulation schemes or combinations thereof. A symbol of a binary-symbol (e.g., binary-level) modulation scheme may be operable to represent one bit of data (e.g., a symbol may represent a logic 1 or a logic 0), and may be an example of an M-ary modulation scheme where M is equal to two. Examples of binary-symbol modulation schemes include non-return-to-zero (NRZ), unipolar encoding, bipolar encoding, Manchester encoding, pulse amplitude modulation (PAM) having two symbols (e.g., PAM2), and others. A symbol of a multi-symbol modulation scheme may be operable to represent more than one bit of data (e.g., a symbol may represent a logic 00, a logic 01, a logic 10, or a logic 11), and may be an example of an M-ary modulation scheme where M is greater than or equal to three. For example, a multi-symbol signal may be modulated using a modulation scheme that includes at least three levels to encode more than one bit of information. Multi-symbol modulation schemes and symbols may be referred to as non-binary, multi-bit, or higher-order modulation schemes and symbols. Examples of multi-symbol modulation schemes include PAM3, PAM4, PAM8, and so on, quadrature amplitude modulation (QAM), quadrature phase shift keying (QPSK), and others.

The host system 105 and the memory system 110 may exchange redundancy information, parity information, or both along with corresponding data. The redundancy and parity information may be used to check for and/or correct errors that occur in the data over time. The memory system 110 and the host system 105 may support one or more error check schemes, including a CRC scheme an error detection code (EDC) scheme, or other types of error detection or checking algorithms. The memory system 110 and the host system 105 may similarly support one or more error correction schemes, including error correction code (ECC), single device data correction (SDDC), or the like. In some cases, the error check operation and the error correction operation may be performed at a single device on one side of the channels 115. For example, when the memory system 110 reads data, the memory system 110 may perform the error check and correction before sending the corrected data to the host system 105, or the host system 105 may receive the data and perform the error check and correction on the host-side. However, such operations may not account for any errors that may occur due to transfer of the data via the channels 115 (e.g., an interface or link between the host system 105 and the memory system 110).

Additionally, or alternatively, some error check and correction schemes, such as SDDC, among others, may operate according to one or more assumptions about the data. For example, for SDDC to be successful, it may be assumed that a single memory device 145 in the memory system 110 includes erred data. In such cases, errors that are incurred via the channels 115 or elsewhere may reduce accuracy and reliability of the error check and correction operations because these errors may not be accounted for.

Techniques, systems, and devices described herein provide for splitting the generation of redundancy information and the generation of parity information for data protection. For example, the separation of the redundancy generation and the parity generation may provide for the memory system 110 and the host system 105 to use the redundancy information as a check for any errors that may occur via the channels 115, and to use the redundancy information and the parity information as a check for any errors that may occur due to storage of the data within the one or more memory devices 145. The detection of link-driven versus die-driven errors may improve reliability of error detection data communication between the memory system 110 and the host system 105.

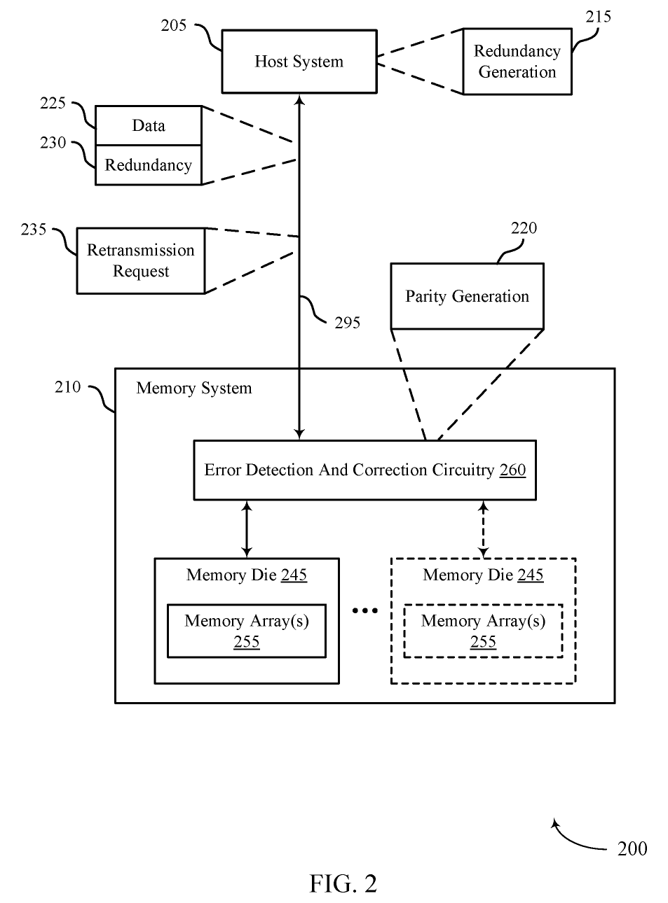

FIG. 2 illustrates an example of a system 200 (e.g., a memory architecture) that supports determination of errors as link-driven or die-driven errors in accordance with examples as disclosed herein. The system 200 represent an example of a system 100 or one or more components thereof. As described herein, the system 200 may include a memory system 210 that supports system-level (e.g., module-level) error correction before data is conveyed to a host system 205 or after data is received from the host system 205 and before the data is stored to one or more memory dies 245. The memory system 210 and the host system 205 may represent examples of corresponding systems as described herein, including with reference to FIG. 1. In this example, the memory system 210 and the host system 205 may communicate data 225 via an interface 295. To reduce undetected errors that may occur in the data 225 due to transfer via the interface 295, the redundancy generation 215 and the parity generation 220 may be split across the interface 295, such that the redundancy information may be used for determining whether any errors occurred across the interface 295 (e.g., a link).

The memory system 210 may represent an example of a module including one or more memory dies 245, which may represent examples of the memory devices 145 described with reference to FIG. 1. Each of the memory dies 245 may include one or more memory arrays 255 configured to store data, parity bits, metadata, or the like. In some examples, each of the memory dies 245 may also include a respective on-die ECC engine (not pictured), which may represent an example of error correction circuitry configured to detect errors, correct errors, or both within the data stored to the memory arrays 255 of the memory die 245.

The memory system 210 may include the error detection and correction circuitry 260, which may be included within, for example, a data buffer, a memory system controller, one or more other components, distributed across the memory dies 245, or any combination thereof. The error detection and correction circuitry 260 may be configured to perform a system-level error check and correction functionality. That is, the data may be checked and/or corrected at a system level by the error detection and correction circuitry 260 before the data is transferred via the interface 295 the host system 205, which may improve performance, in some examples. For example, transferring parity bits from one or more of the memory dies 245 configured to store parity information to the error detection and correction circuitry 260 may consume less power and overhead than transferring the parity bits off of the memory system 210 to the host system 205. Shipping the extra bits (e.g., 80 extra parity bits, or some other quantity) to the host system 205 may increase energy and overhead. Additionally, or alternatively, exposing the parity bits outside of the memory system 210 may pose security risks. Since the error detection and correction circuitry 260 is local to the memory system 210, the energy expended to move the extra bits may be less than energy to ship the bits to the host system 205, and security within the memory system 210 may be maintained.

Moreover, as described herein, the error detection and correction circuitry 260 may support parity generation 220 at the memory system 210, which may facilitate the separation of the parity generation 220 at the memory system 210 from the redundancy generation 215 at the host system 205.

The error detection and correction circuitry 260 may include one or more logic components configured to support (e.g., execute) ECC, error-detecting code (EDC), CRC, other algorithms, or any combination thereof. In some examples, the error detection and correction circuitry 260 may transfer one or more bits of metadata with the data 225 to the host system 205 to indicate that system-level error correction was performed, to indicate whether the errors were corrected or not, to indicate an address of the data 225, or other information associated with the data 225. The host system 205 may thereby receive the data 225 with an indication of where error correction was performed, and may determine how to address any potential errors the host system 205 may detect accordingly. It may be beneficial to have all correction capability in the error detection and correction circuitry 260 using all of the parity bits retrieved from the memory dies 245. Such system-level error correction may be performed in addition to the on-die error correction, in some examples.

Additionally, or alternatively, techniques described herein may provide for one or more of the on-die ECC engines to be turned off or otherwise disabled, such that the extra parity bits within each memory die 245 may be transferred to the error detection and correction circuitry 260 to enhance the system-level error correction. For example, each memory die 245 may include one or more mode registers configured to indicate whether on-die error correction is enabled or disabled. If the on-die error correction is disabled at one or more of the memory dies 245, those memory dies 245 may be configured to transfer extra on-die parity bits stored at the memory dies 245 to the error detection and correction circuitry 260. For example, when a read command is received, a memory die 245 may retrieve the requested data and transfer the requested data in addition to one or more of the on-die parity bits to the error detection and correction circuitry 260. The error detection and correction circuitry 260 may use the extra parity bits to perform the error detection and correction operations. The extra bits (e.g., eight bits from each memory die 245, or 16 bits from each memory die 245, for example) may improve an accuracy and reliability of the system-level error correction. For example, the error detection and correction circuitry 260 may be able to detect and correct an increased quantity of errors with the increased quantity of parity bits. In some examples, if the detection capabilities of the error detection and correction circuitry 260 are increased, the error detection and correction circuitry 260 may detect one or more errors that the error detection and correction circuitry 260 may not be capable of correcting. In such cases, the error detection and correction circuitry 260 may send the data, along with metadata, to the host system 205 via the interface 295 where the metadata may indicate that there are uncorrected errors.

By transferring and aggregating all of the parity bits within the memory system 210 at the error detection and correction circuitry 260, the error detection and correction circuitry 260 may support error correction for larger portions of data at a time. For example, if an entire memory die 245 is corrupted or otherwise goes down, the increased quantity of parity bits may facilitate reconstruction and correction of the whole memory die 245 by the error detection and correction circuitry 260 at the system level (e.g., chip kill may be replicated in the error detection and correction circuitry 260).

In some examples, the error detection and correction circuitry 260 may include one or more logic gates or other components configured to perform varying levels of error correction. For example, the error detection and correction circuitry 260 may support error correction in accordance with a first algorithm and a first quantity of parity bits when on-die error correction is enabled and system-level error correction is enabled using parity bits from one or more dies configured to store only parity information. Additionally, or alternatively, if system-level error correction is disabled, the error detection and correction circuitry 260 may refrain from performing any error correction or detection on the data before transferring the data to the host system 205. If on-die error correction is disabled and system-level error correction is enabled, the error detection and correction circuitry 260 may support error correction in accordance with a second algorithm and a second quantity of parity bits that may be greater than the first quantity. The second algorithm may be more complex and may be capable of correcting more errors per codeword than the first algorithm, in some examples. The logic within the error detection and correction circuitry 260 may similarly support one or more other error correction algorithms based on a value of one or more mode registers and a quantity of parity bits that are available. The error detection and correction circuitry 260 may thereby use a logic process for error correction instead of a DRAM process, or other type of process, which may improve performance of the error correction as compared with only on-die error correction or host-level error correction.

Although the system-level error correction is described herein as being performed within the error detection and correction circuitry 260, it is to be understood that, in some examples, the system-level error correction may be performed by any one or more components within the memory system 210 that are external to or distributed across the one or more memory dies 245.

The techniques described here leverage the error detection and correction circuitry 260 at the system-level within the memory system 210 to provide for separation of the parity generation 220 from the redundancy generation 215. For example, as described herein, the host system 205 may perform the redundancy generation 215. If the host system 205 is to write data 225 to the memory system 210, the host system 205 may perform the redundancy generation 215 to generate the redundancy 230 for the data 225. The redundancy 230 may include one or more CRC bits, or other redundant information associated with the data 225 (e.g., one or more redundant bits). As an example, if the data 225 includes 256 bits (e.g., 32 bytes, or half of a cache line), the redundancy 230 may include 16 CRC bits, or some other quantity of bits associated with the data 225. The interface 295 may convey the 272 total bits to the memory system 210. The host system 205 may transmit the data 225 and the redundancy 230 to the memory system 210 via the interface 295. The host system 205 may transmit a write command, in some examples, that requests the memory system 210 write the data 225.

The memory system 210 may receive the data 225 and the redundancy 230 and may perform an error check operation (e.g., in accordance with a CRC algorithm, for example). The error check operation may be performed by the error detection and correction circuitry 260 at the system-level. For example, the error detection and correction circuitry 260 may use the redundancy 230 and an error check algorithm to determine whether any errors were incurred in the data 225 during transfer of the data 225 via the interface 295. By performing the redundancy generation 215 at the host system 205 before the parity generation 220, the error detection and correction circuitry 260 may be able to use the redundancy 230 to determine whether any interface-induced errors occurred, irrespective of any errors due to storage within the memory system 210, for example. If the error detection and correction circuitry 260 detects any errors in the data 225, the error detection and correction circuitry 260 may perform error correction. The error correction may be performed using an error correction operation (e.g., protocol, technique, or the like) selected from multiple candidate error correction operations supported by the error detection and correction circuitry 260. For example, the error detection and correction circuitry 260 may support error correction via retransmission request, error correction via an error correction operation using redundancy information, other types of error correction, or any combination thereof.

If the error detection and correction circuitry 260 detects any errors in the data 225 and determines to perform error correction using the redundancy 230, the error detection and correction circuitry 260 may execute an error correction operation to correct the one or more errors in the data using the redundancy 230. Additionally, or alternatively, if the error detection and correction circuitry 260 detects one or more errors in the data and determines to perform error correction by requesting a retransmission, the error detection and correction circuitry 260 may transmit a retransmission request 235 to the host system 205. The error detection and correction circuitry 260 may transmit one or more retransmission requests 235 to the host system 205 in response to received write data 225 until the memory system 210 receives the data 225 without any errors. Additionally, or alternatively, the error detection and correction circuitry may transmit one or more retransmission requests 235 (e.g., a threshold quantity) before using the redundancy 230 to perform error correction.

If the error detection and correction circuitry 260 performs the error check operation on received data 225 (e.g., via an initial transmission or a retransmission of the data 225) and does not detect any errors in the data 225 using the redundancy 230, the error detection and correction circuitry 260 may determine that no errors were introduced over the interface 295, and the error detection and correction circuitry 260 may perform the parity generation 220. For example, the error detection and correction circuitry 260 may generate, in accordance with one or more algorithms, such as an ECC algorithm, or other type of algorithm, parity information associated with the data 225.

In some examples, the error detection and correction circuitry 260 may re-generate the redundancy 230 for the data 225. For example, the error detection and correction circuitry 260 may re-generate or otherwise repurpose the redundancy 230 received from the host system 205. Additionally, or alternatively, the error detection and correction circuitry 260 may generate new redundancy 230 associated with the data (e.g., based on a CRC algorithm or other algorithm at the memory system 210).

The error detection and correction circuitry 260 may write the data 225, the parity information, and the redundancy 230 to the one or more memory dies 245 for storage. The data may be written to one or more target memory dies 245 based on an address indicated via the write command. In some examples, one or more of the memory dies 245 may be a parity die configured to store the parity information, and the error detection and correction circuitry 260 may write the parity information to the parity die accordingly. Similarly, one or more of the memory dies 245 may be a redundancy die configured to store redundancy information, and the error detection and correction circuitry 260 may write the redundancy to the redundancy die accordingly. Additionally, or alternatively, the redundancy 230, the parity information, or both may be stored in a same memory die 245 as the data. In some examples, there may be 18 memory dies 245 within the memory system 210, including a parity die, a redundancy die, and 16 dies for data storage. In such cases, the data 225 (e.g., 256 bits of data), the redundancy 230 (e.g., 16 bits of redundancy) and the parity information (e.g., 16 bits of parity) may be sent as 288 total bits via one or more bursts, where the bits may be divided across bursts (e.g., clock cycles). In some examples, the same data 225 may be written to each of the memory dies 245 (e.g., each of the 16 storage dies), or the data 225 may be written to a target memory die 245, and different data may be written to other memory dies 245. In some examples, the combination of the data 225, the parity information, and the redundancy 230 may be referred to as a codeword.

The memory system 210 may similarly write other codewords and data to the memory dies 245 and may perform an error check operation using the error detection and correction circuitry 260 before performing the parity generation 220 and data storage in order to detect any errors over the interface 295.

The parity generation 220 and redundancy generation 215 separated across the interface 295 may similarly support detection of link-driven errors (e.g., errors due to transmission via the interface 295) versus die-driven or core-driven errors (e.g., errors incurred during storage of data by the memory system 210). For example, in response to a read command, the memory system 210 may read the data 225 from one or more of the memory dies 245 to the error detection and correction circuitry 260. The memory system 210 may read the redundancy 230 and the parity information stored with or otherwise associated with the requested data 225. The error detection and correction circuitry 260 may perform an error check operation using the redundancy 230. For example, the error detection and correction circuitry 260 may determine whether any of the memory dies 245 include erred data. The error detection and correction circuitry 260 may use the redundancy 230 and an error check algorithm (e.g., CRC), to detect which of the memory dies 245 includes the erred data. The error detection and correction circuitry 260 may subsequently use the parity information to detect which bits within the identified memory die 245 are erred.

The error detection and correction circuitry 260 may perform an error correction operation, in some examples, to correct the detected errors in the data 225 before transmitting the data 225 to the host system 205. The error correction operation may be an ECC operation, or some other type of correction. Additionally, or alternatively, the error detection and correction circuitry 260 may generate metadata that indicates the one or more errors, addresses associated with the one or more errors, or the like and the error detection and correction circuitry 260 may send the metadata to the host system 205 with the data 225.

After performing the error check operation and the error correction operation, the error detection and correction circuitry 260 may transmit the data 225 and the redundancy 230 back to the host system 205 in response to the read command. In some examples, the error detection and correction circuitry 260 may re-generate the redundancy 230 after the error check operation (e.g., using a same CRC algorithm). Additionally, or alternatively, the error detection and correction circuitry 260 may use the redundancy 230 for the error check operation and may send the same redundancy 230 to the host system 205 with the data 225.

The host system 205 may receive the data 225 and the redundancy 230 and may assume (e.g., based on a configuration, a data sheet, or some other indication) that the memory system 210 performed error correction. In some examples, the memory system 210 may send metadata to the host system 205 that indicates that the memory system 210 performed the error correction. The host system 205 may perform an error check operation on the received data 225 using the redundancy 230. If any error(s) are detected, the host system 205 may assume that the errors are due to the interface 295 and may take corrective action accordingly. For example, the host system 205 may resend the read request, or may account for the errors when processing the data 225, may adjust one or more parameters associated with a connection to the memory system 210, may alert a user of the errors due to the interface 295, or any combination thereof.

The described techniques thereby include separation of the error check operation from an error correction operation in order to check for errors that may occur via the interface 295 before parity generation 220 or other error correction. The described link error check may provide for the memory system 210 and the host system 205 to detect and correct errors sent via the link before processing or storing the data. In some examples, a link-driven error may be indicative of a malicious actor or other unauthorized access to the interface 295, and the host system 205 and the memory system 210 may execute one or more protective measures accordingly. For example, the host system 205, the memory system 210, or both may retransmit data, may refrain from continuing communications via the interface 295, may alert a user of a potential security breach, or the like.

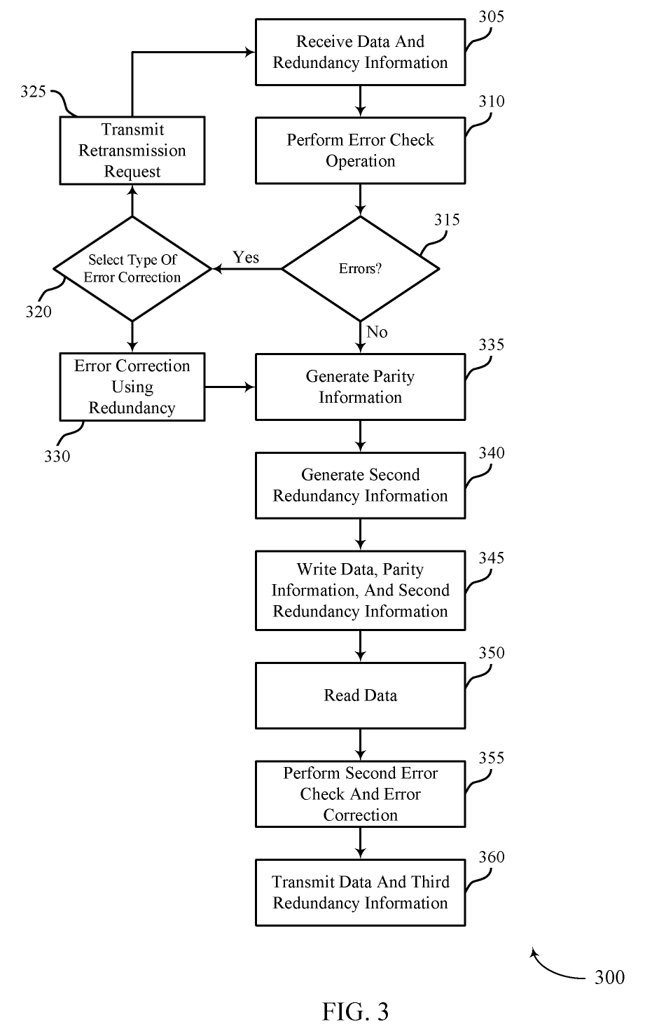

FIG. 3 shows an example of a flow diagram 300 that supports determination of errors as link-driven or die-driven errors in accordance with examples as disclosed herein. The flow diagram 300 may implement or be implemented by aspects of the system 100 or the system 200, as described with reference to FIGS. 1 and 2. For example, the flow diagram illustrates operations performed by a memory system, which may represent an example of the memory system 110 or the memory system 210, as described with reference to FIGS. 1 and 2, respectively.

Although shown in a particular sequence or order, unless otherwise specified, the order of the processes may be modified. Thus, the illustrated examples are used as examples, and the illustrated processes may be performed in a different order, and some processes may be performed in parallel. Additionally, one or more processes may be omitted in various examples. Thus, not all processes are used in every example. Other flows are possible. The flow diagram 300 illustrates operations to detect whether errors are link-driven or die-driven errors.

At 305, the memory system may receive, from a host system and via an interface between the host system and the memory system, data and redundancy information associated with the data. In some examples, the memory system may receive a write command or other request to write the data.

At 310, the memory system may perform an error check operation on the data in accordance with the redundancy information. The error check operation may check for one or more errors in the data that may be a result of the transfer of the data via the interface (e.g., link-driven errors). The error check operation may be an EDC operation, a CRC operation, or some other form of error check using the redundancy information.

At 315, the memory system may determine whether the data includes one or more errors based on the error check operation. The memory system may determine whether to perform error correction based on the error check operation. For example, the memory system may determine to perform error correction if the error check operation detects one or more errors (e.g., at least one error or some threshold quantity of errors), and the memory system may determine to refrain from performing error correction if the error check operation detects an absence of errors (e.g., zero errors or less than a threshold quantity of errors). In some examples, the error check operation may detect one or more errors in the data. In such cases, at 320, the memory system may determine to perform the error correction and may select a type of the error correction to perform. The type of the error correction may be selected from a set of candidate error correction types supported by the memory system. For example, the memory system may support error correction via a retransmission request, error correction at the memory system using redundancy information, some other type of error correction, or any combination thereof.

At 325, if the memory system determines to perform error correction via retransmission, the memory system may transmit, via the interface, a retransmission request to the host system based on the one or more errors. The memory system may delete or otherwise ignore the previously transmitted data and may wait for the retransmission. The host system may retransmit the data and the redundancy information in response to the retransmission request, and the memory system may continue to 305.

At 330, if the memory system determines to perform error correction at the memory system using the redundancy information, the memory system may perform the error correction operation. For example, the memory system may perform a CRC operation or some other type of error correction operation using the redundancy bits received from the host system to correct the errors in the data.

Alternatively, if the error check operation does not detect any errors in the data, the memory system may refrain from transmitting the retransmission request or performing error correction.

After correcting the errors in the data at 330, receiving a retransmission of the data without errors (e.g., based on a request transmitted at 325) or detecting an absence of errors at 315, the memory system may proceed to 335 to perform a parity generation operation on the data. For example, at 335, the memory system may generate parity information associated with the data based on an absence of link-driven errors in the data. The memory system may perform the parity generation according to one or more error correction algorithms, including an ECC algorithm, or some other type of error correction algorithm.

At 340, in some examples, the memory system may generate second redundancy information associated with the data. The second redundancy information may, in some examples, be the same as the redundancy information received from the host system. That is, the memory system may re-use the received redundancy information. Additionally, or alternatively, the memory system may perform a redundancy generation operation to generate the second redundancy information based on the data and one or more redundancy generation schemes. The second redundancy information may be configured for checking which memory device, of one or more memory devices within the memory system, includes an error or otherwise erred data.

At 345, the memory system may write the data, the parity information associated with the data, and the second redundancy information to one or more memory devices within the memory system. The memory system may store the data to one or more first memory devices and the parity and redundancy information to one or more second memory devices, or the memory system may store the redundancy information, parity information, and data to the same one or more memory devices, or some combination, as described in further detail with reference to FIG. 2. The memory system may write the data, parity information, and redundancy information via one or more burst writes, in some examples. The data, parity information, and redundancy information may be stored by the memory system for some time period and may be associated with (e.g., mapped to, identified by) respective address information. In some examples, one or more errors may occur in the data over time due to various environmental factors, voltage shifts, cell degradation or the like.

At 350, the memory system may receive a request to read the data. The request may be a read command or other request that indicates address information identifying the data. The memory system may retrieve, in response to the request, the requested data from the one or more memory devices along with the corresponding parity information and redundancy information associated with the data.

At 355, the memory system may perform a second error check operation in response to reading the data and using the redundancy information. For example, the memory system may pull the data and corresponding redundancy information from the one or more memory devices to error check and correction circuitry or other system-level circuitry for performance of the second error check operation. The second error check operation may be a CRC operation, or some other type of operation that uses the second redundancy information to check for errors in the data and, if an error is detected, to determine which memory device of the memory system includes the erred data. The memory system may additionally, or alternatively, perform a second error check and correction operation on the data. The second error check and correction operation may be performed using the parity information retrieved from the one or more memory devices. For example, the memory system may use the parity information to determine which bit(s) within the data include errors, and may subsequently correct those errors using ECC or other error correction schemes and according to the parity information. In some examples, if one or more errors are detected in the data, the memory system may increase a level of error correction to be used for subsequent error check and correction operations. For example, the memory system may set a register or store some other indication that increases a severity of an error check and correction algorithm used by the memory system.

At 360, after performing the second error check and correction operation, the memory system may transmit, to the host system via the interface, the corrected data and third redundancy information associated with that data. The third redundancy information may be the same as the second redundancy information previously stored within the one or more memory devices and used by the memory system to check for errors. Additionally, or alternatively, the memory system may perform another redundancy generation operation to generate the third redundancy information for the corrected data.

In some examples, the memory system may transmit metadata to the host system in addition to the data. The metadata may indicate, for example, whether the memory system corrected the data, whether the memory system detected any errors in the data, a quantity of errors detected in the data, a type of the detected errors, address information associated with the detected errors, other information associated with the erred data, or any combination thereof.

The host system may receive the data, the third redundancy information, and the metadata, and may perform another error check operation accordingly. For example, the host system may use the third redundancy information to check for any errors in the data. If the host system detects any error in the data, the host system may assume that the detected error is due to transfer of the data via the interface instead of die-driven errors, at least because the metadata may indicate that the memory system performed error correction before returning the read data.

The described techniques may thereby provide for improved error detection and distinction of link-driven versus die-driven errors within a memory system, which may improve security and reliability of data stored and exchanged between a memory system and a host system during one or more relatively high security applications.

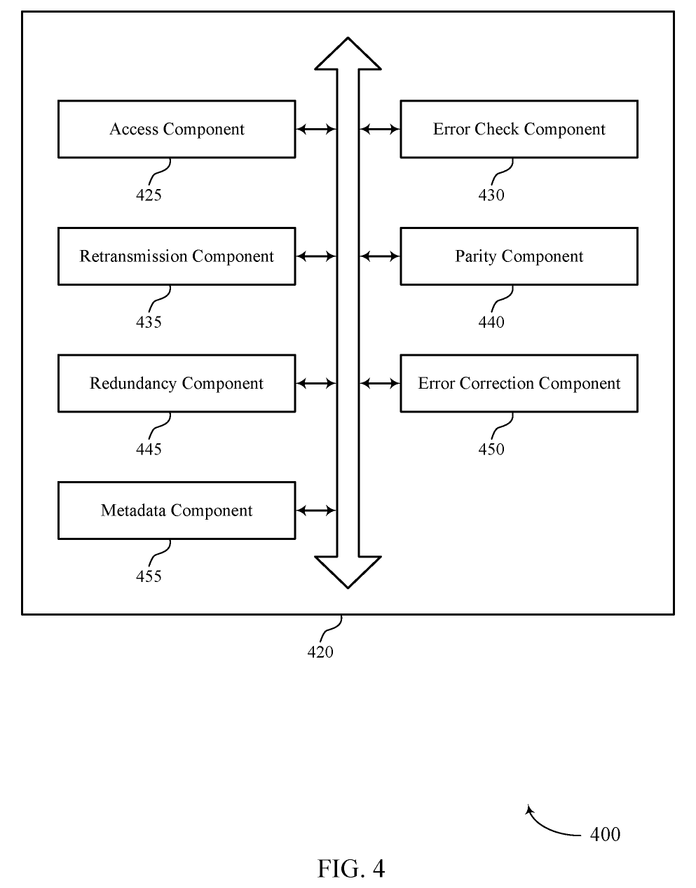

FIG. 4 shows a block diagram 400 of a memory system 420 that supports determination of errors as link-driven or die-driven errors in accordance with examples as disclosed herein. The memory system 420 may be an example of aspects of a memory system as described with reference to FIGS. 1 through 3. The memory system 420, or various components thereof, may be an example of means for performing various aspects of determination of errors as link-driven or die-driven errors as described herein. For example, the memory system 420 may include an access component 425, an error check component 430, a retransmission component 435, a parity component 440, a redundancy component 445, an error correction component 450, a metadata component 455, or any combination thereof. Each of these components, or components of subcomponents thereof (e.g., one or more processors, one or more memories), may communicate, directly or indirectly, with one another (e.g., via one or more buses).

The access component 425 may be configured as or otherwise support a means for receiving, via an interface coupled with one or more memory devices of the memory system, data and redundancy information associated with the data. The error check component 430 may be configured as or otherwise support a means for performing an error check operation on the data in accordance with the redundancy information, where the error check operation checks for one or more errors in the data due to transfer of the data via the interface. The error correction component 450 may be configured as or otherwise support a means for determining whether to perform error correction based at least in part on the error check operation. In some examples, the access component 425 may be configured as or otherwise support a means for writing, to the one or more memory devices, the data and parity information associated with the data based at least in part on determining whether to perform the error correction.

In some examples, the retransmission component 435 may be configured as or otherwise support a means for transmitting, via the interface and based at least in part on determining to perform the error correction, a retransmission request, wherein the retransmission request facilitates the error correction, and wherein determining to perform the error correction is based at least in part on identification, during the error check operation, of at least one error in the data due to the transfer of the data via the interface. In some examples, the retransmission component 435 may be configured as or otherwise support a means for receiving, via the interface in response to the retransmission request, a retransmission of the data and the redundancy information. In some examples, the error check component 430 may be configured as or otherwise support a means for performing a second error check operation on the data in accordance with the redundancy information and the retransmission.

In some examples, the parity component 440 may be configured as or otherwise support a means for generating the parity information associated with the data based at least in part on identification, during the second error check operation, of an absence of errors in the data, where writing the data and the parity information associated with the data is based at least in part on generation of the parity information.

In some examples, the redundancy component 445 may be configured as or otherwise support a means for generating second redundancy information associated with the data based at least in part on identification, during the second error check operation, of the absence of errors in the data, the second redundancy information being the same as or different from the redundancy information. In some examples, the redundancy component 445 may be configured as or otherwise support a means for writing, with the data and the parity information, the second redundancy information to the one or more memory devices.

In some examples, the retransmission component 435 may be configured as or otherwise support a means for transmitting, via the interface, a second retransmission request based at least in part on identification, during the second error check operation, of at least one error in the data due to the transfer of the data via the interface, where the one or more retransmission requests are transmitted until the data is received, via the interface, with an absence of errors.

In some examples, the error correction component 450 may be configured as or otherwise support a means for performing, using the redundancy information associated with the data, an error correction operation to correct the one or more errors in the data, where the error correction operation is performed based at least in part on determining to perform the error correction in accordance with identification, during the error check operation, of the one or more errors in the data, and where generation of the parity information is based at least in part on performance of the error correction operation.

In some examples, the parity component 440 may be configured as or otherwise support a means for generating the parity information associated with the data based at least in part on determining to refrain from performing the error correction in accordance with identification, during the error check operation, of an absence of errors in the data, where writing the data and the parity information associated with the data is based at least in part on generation of the parity information.

In some examples, the redundancy component 445 may be configured as or otherwise support a means for generating second redundancy information associated with the data, the second redundancy information being the same as or different from the redundancy information. In some examples, the access component 425 may be configured as or otherwise support a means for writing, with the data and the parity information, the second redundancy information to the one or more memory devices, where the second redundancy information is configured for checking which memory device, of the one or more memory devices, includes an error.

In some examples, the access component 425 may be configured as or otherwise support a means for receiving a request to read the data from the one or more memory devices. In some examples, the access component 425 may be configured as or otherwise support a means for reading, from the one or more memory devices in response to the request, the data, the parity information associated with the data, and second redundancy information associated with the data. In some examples, the error check component 430 may be configured as or otherwise support a means for performing a second error check operation on the data based at least in part on reading the data and in accordance with the second redundancy information, where the second error check operation identifies a memory device from among the one or more memory devices that includes one or more second errors. In some examples, the error correction component 450 may be configured as or otherwise support a means for performing an error check and correction operation on the data associated with the memory device identified by the second error check operation and in accordance with the parity information, where the error check and correction operation corrects the one or more second errors in the data in accordance with the parity information.

In some examples, the access component 425 may be configured as or otherwise support a means for transmitting, via the interface based at least in part on correction of the one or more second errors and in response to the request, the data and the second redundancy information associated with the data, where the second redundancy information is configured to facilitate detection of one or more third errors in the data due to transmission of the data via the interface.

In some examples, the error correction component 450 may be configured as or otherwise support a means for increasing a level of error correction for a subsequent error check and correction operation based at least in part on detecting the one or more second errors in the data.

In some examples, the metadata component 455 may be configured as or otherwise support a means for transmitting, via the interface, metadata that indicates a quantity of the one or more second errors in the data, a type of the one or more second errors, address information associated with the one or more second errors, or any combination thereof.

In some examples, the error check component 430 may be configured as or otherwise support a means for performing the error check operation in accordance with a CRC algorithm.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

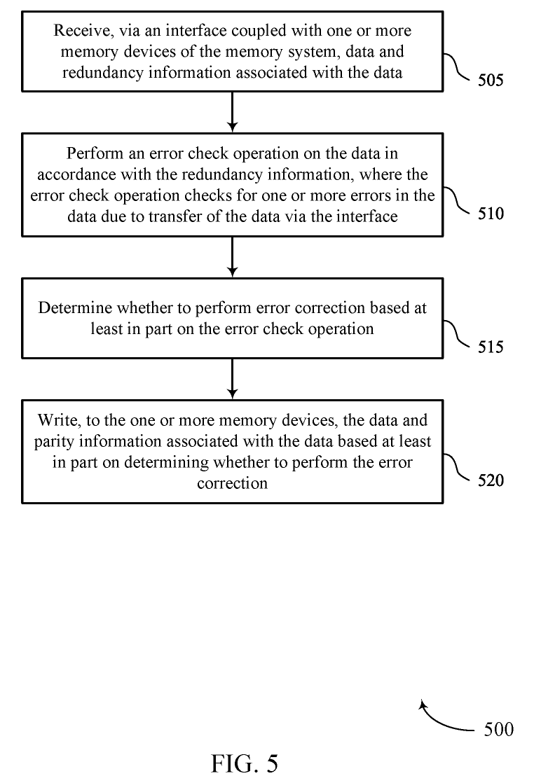

FIG. 5 shows a flowchart illustrating a method 500 that supports determination of errors as link-driven or die-driven errors in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include receiving, via an interface coupled with one or more memory devices of the memory system, data and redundancy information associated with the data. In some examples, aspects of the operations of 505 may be performed by an access component 425 as described with reference to FIG. 4.

At 510, the method may include performing an error check operation on the data in accordance with the redundancy information, where the error check operation checks for one or more errors in the data due to transfer of the data via the interface. In some examples, aspects of the operations of 510 may be performed by an error check component 430 as described with reference to FIG. 4.

At 515, the method may include determining whether to perform error correction based at least in part on the error check operation. In some examples, aspects of the operations of 515 may be performed by an error correction component 450 as described with reference to FIG. 4.

At 520, the method may include writing, to the one or more memory devices, the data and parity information associated with the data based at least in part on determining whether to perform the error correction. In some examples, aspects of the operations of 520 may be performed by an access component 425 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing (e.g., to cause the apparatus to perform) the following aspects of the present disclosure:

Aspect 1: A method, apparatus, or non-transitory computer-readable medium including operations, features, circuitry, logic, means, or instructions, or any combination thereof for receiving, via an interface coupled with one or more memory devices of the memory system, data and redundancy information associated with the data; performing an error check operation on the data in accordance with the redundancy information, where the error check operation checks for one or more errors in the data due to transfer of the data via the interface; determining whether to perform error correction based at least in part on the error check operation; and writing, to the one or more memory devices, the data and parity information associated with the data based at least in part on determining whether to perform the error correction.

Aspect 2: The method, apparatus, or non-transitory computer-readable medium of aspect 1, further including operations, features, circuitry, logic, means, or instructions, or any combination thereof for transmitting, via the interface and based at least in part on determining to perform the error correction, a retransmission request, wherein the retransmission request facilitates the error correction, and wherein determining to perform the error correction is based at least in part on identification, during the error check operation, of at least one error in the data due to the transfer of the data via the interface; receiving, via the interface in response to the retransmission request, a retransmission of the data and the redundancy information; and performing a second error check operation on the data in accordance with the redundancy information and the retransmission.

Aspect 3: The method, apparatus, or non-transitory computer-readable medium of aspect 2, further including operations, features, circuitry, logic, means, or instructions, or any combination thereof for generating the parity information associated with the data based at least in part on identification, during the second error check operation, of an absence of errors in the data, where writing the data and the parity information associated with the data is based at least in part on generation of the parity information.

Aspect 4: The method, apparatus, or non-transitory computer-readable medium of aspect 3, further including operations, features, circuitry, logic, means, or instructions, or any combination thereof for generating second redundancy information associated with the data based at least in part on identification, during the second error check operation, of the absence of errors in the data, the second redundancy information being the same as or different from the redundancy information and writing, with the data and the parity information, the second redundancy information to the one or more memory devices.

Aspect 5: The method, apparatus, or non-transitory computer-readable medium of any of aspects 2 through 4, further including operations, features, circuitry, logic, means, or instructions, or any combination thereof for transmitting, via the interface, a second retransmission request based at least in part on identification, during the second error check operation, of at least one error in the data due to the transfer of the data via the interface, where the method, apparatus, or non-transitory computer-readable medium further includes operations, features, circuitry, logic, means, or instructions, or any combination thereof for transmitting one or more retransmission requests until the data is received, via the interface, with an absence of errors.

Aspect 6: The method, apparatus, or non-transitory computer-readable medium of aspect 1, further including operations, features, circuitry, logic, means, or instructions, or any combination thereof for performing, using the redundancy information associated with the data, an error correction operation to correct the one or more errors in the data, wherein the error correction operation is performed based at least in part on determining to perform the error correction in accordance with identification, during the error check operation, of the one or more errors in the data, wherein generation of the parity information is based at least in part on performance of the error correction operation

Aspect 7: The method, apparatus, or non-transitory computer-readable medium of aspect 1, further including operations, features, circuitry, logic, means, or instructions, or any combination thereof for generating the parity information associated with the data based at least in part on determining to refrain from performing the error correction in accordance with identification, during the error check operation, of an absence of errors in the data, where writing the data and the parity information associated with the data is based at least in part on generation of the parity information.

Aspect 8: The method, apparatus, or non-transitory computer-readable medium of any of aspects 1 through 7, further including operations, features, circuitry, logic, means, or instructions, or any combination thereof for generating second redundancy information associated with the data, the second redundancy information being the same as or different from the redundancy information and writing, with the data and the parity information, the second redundancy information to the one or more memory devices, where the second redundancy information is configured for checking which memory device, of the one or more memory devices, includes an error.

Aspect 9: The method, apparatus, or non-transitory computer-readable medium of any of aspects 1 through 8, further including operations, features, circuitry, logic, means, or instructions, or any combination thereof for receiving a request to read the data from the one or more memory devices; reading, from the one or more memory devices in response to the request, the data, the parity information associated with the data, and second redundancy information associated with the data; performing a second error check operation on the data based at least in part on reading the data and in accordance with the second redundancy information, where the second error check operation identifies a memory device from among the one or more memory devices that includes one or more second errors; and performing an error check and correction operation on the data associated with the memory device identified by the second error check operation and in accordance with the parity information, where the error check and correction operation corrects the one or more second errors in the data in accordance with the parity information.

Aspect 10: The method, apparatus, or non-transitory computer-readable medium of aspect 9, further including operations, features, circuitry, logic, means, or instructions, or any combination thereof for transmitting, via the interface based at least in part on correction of the one or more second errors and in response to the request, the data and the second redundancy information associated with the data, where the second redundancy information is configured to facilitate detection of one or more third errors in the data due to transmission of the data via the interface.

Aspect 11: The method, apparatus, or non-transitory computer-readable medium of any of aspects 9 through 10, further including operations, features, circuitry, logic, means, or instructions, or any combination thereof for increasing a level of error correction for a subsequent error check and correction operation based at least in part on detecting the one or more second errors in the data.

Aspect 12: The method, apparatus, or non-transitory computer-readable medium of any of aspects 9 through 11, further including operations, features, circuitry, logic, means, or instructions, or any combination thereof for transmitting, via the interface, metadata that indicates a quantity of the one or more second errors in the data, a type of the one or more second errors, address information associated with the one or more second errors, or any combination thereof.

Aspect 13: The method, apparatus, or non-transitory computer-readable medium of any of aspects 1 through 12, further including operations, features, circuitry, logic, means, or instructions, or any combination thereof for performing the error check operation in accordance with a CRC algorithm.

It should be noted that the aspects described herein describe possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (e.g., in conductive contact with, connected with, coupled with) one another if there is any electrical path (e.g., conductive path) between the components that can, at any time, support the flow of signals (e.g., charge, current, voltage) between the components. A conductive path between components that are in electronic communication with each other (e.g., in conductive contact with, connected with, coupled with) may be an open circuit or a closed circuit based on the operation of the device that includes the connected components. A conductive path between connected components may be a direct conductive path between the components or may be an indirect conductive path that includes intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to condition of moving from an open-circuit relationship between components in which signals are not presently capable of being communicated between the components (e.g., over a conductive path) to a closed-circuit relationship between components in which signals are capable of being communicated between components (e.g., over the conductive path). When a component, such as a controller, couples other components together, the component may initiate a change that allows signals to flow between the other components over a conductive path that previously did not permit signals to flow.

A switching component (e.g., a transistor) discussed herein may be a field-effect transistor (FET), and may include a source (e.g., a source terminal), a drain (e.g., a drain terminal), a channel between the source and drain, and a gate (e.g., a gate terminal). A conductivity of the channel may be controlled (e.g., modulated) by applying a voltage to the gate which, in some examples, may result in the channel becoming conductive. A switching component may be an example of an n-type FET or a p-type FET.

The description set forth herein, in connection with the appended drawings, describes example configurations and does not represent all the examples that may be implemented or that are within the scope of the claims. The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Similar components may be distinguished by following the reference label by one or more dashes and additional labeling that distinguishes among the similar components. If just the first reference label is used in the specification, the description is applicable to any one of the similar components having the same first reference label irrespective of the additional reference labels.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The descriptions and drawings are provided to enable a person having ordinary skill in the art to make or use the disclosure. Various modifications to the disclosure will be apparent to the person having ordinary skill in the art, and the techniques disclosed herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices;
an interface coupled with the one or more memory devices; and
processing circuitry coupled with the interface and the one or more memory devices and configured to cause the memory system to:
receive, via the interface, data and redundancy information associated with the data;
perform an error check operation on the data in accordance with the redundancy information, wherein the error check operation checks for one or more errors in the data due to transfer of the data via the interface;
determine whether to perform error correction based at least in part on the error check operation; and
write, to the one or more memory devices, the data and parity information associated with the data based at least in part on determining whether to perform the error correction.

2. The memory system of claim 1, wherein the processing circuitry is further configured to cause the memory system to:
transmit, via the interface and based at least in part on determining to perform the error correction, a retransmission request, wherein the retransmission request facilitates the error correction, and wherein determining to perform the error correction is based at least in part on identification, during the error check operation, of at least one error in the data due to the transfer of the data via the interface;
receive, via the interface in response to the retransmission request, a retransmission of the data and the redundancy information; and
perform a second error check operation on the data in accordance with the redundancy information and the retransmission.

3. The memory system of claim 2, wherein the processing circuitry is further configured to cause the memory system to:
generate the parity information associated with the data based at least in part on identification, during the second error check operation, of an absence of errors in the data, wherein writing the data and the parity information associated with the data is based at least in part on generation of the parity information.

4. The memory system of claim 3, wherein the processing circuitry is further configured to cause the memory system to:
generate second redundancy information associated with the data based at least in part on identification, during the second error check operation, of the absence of errors in the data; and
write, with the data and the parity information, the second redundancy information to the one or more memory devices.

5. The memory system of claim 2, wherein the processing circuitry is further configured to cause the memory system to:
transmit, via the interface, a second retransmission request based at least in part on identification, during the second error check operation, of at least one error in the data due to the transfer of the data via the interface, wherein the processing circuitry is further configured to:
transmit one or more retransmission requests until the data is received, via the interface, with an absence of errors.

6. The memory system of claim 1, wherein the processing circuitry is further configured to cause the memory system to:
perform, using the redundancy information associated with the data, an error correction operation to correct the one or more errors in the data, wherein the error correction operation is performed based at least in part on determining to perform the error correction in accordance with identification, during the error check operation, of the one or more errors in the data, wherein generation of the parity information is based at least in part on performance of the error correction operation.

7. The memory system of claim 1, wherein the processing circuitry is further configured to cause the memory system to:
generate the parity information associated with the data based at least in part on determining to refrain from performing the error correction in accordance with identification, during the error check operation, of an absence of errors in the data, wherein writing the data and the parity information associated with the data is based at least in part on generation of the parity information.

8. The memory system of claim 1, wherein the processing circuitry is further configured to cause the memory system to:
generate second redundancy information associated with the data; and
write, with the data and the parity information, the second redundancy information to the one or more memory devices, wherein the second redundancy information is configured for checking which memory device, of the one or more memory devices, comprises an error.

9. The memory system of claim 1, wherein the processing circuitry is further configured to cause the memory system to:
receive a request to read the data from the one or more memory devices;
read, from the one or more memory devices in response to the request, the data, the parity information associated with the data, and second redundancy information associated with the data;
perform a second error check operation on the data based at least in part on reading the data and in accordance with the second redundancy information, wherein the second error check operation identifies a memory device from among the one or more memory devices that comprises one or more second errors; and
perform an error check and correction operation on the data associated with the memory device identified by the second error check operation and in accordance with the parity information, wherein the error check and correction operation corrects the one or more second errors in the data in accordance with the parity information.

10. The memory system of claim 9, wherein the processing circuitry is further configured to cause the memory system to:
transmit, via the interface based at least in part on correction of the one or more second errors and in response to the request, the data and the second redundancy information associated with the data, wherein the second redundancy information is configured to facilitate detection of one or more third errors in the data due to transmission of the data via the interface.

11. The memory system of claim 9, wherein the processing circuitry is further configured to cause the memory system to:
increase a level of error correction for a subsequent error check and correction operation by the processing circuitry based at least in part on detecting the one or more second errors in the data.

12. The memory system of claim 9, wherein the processing circuitry is further configured to cause the memory system to:
transmit, via the interface, metadata that indicates a quantity of the one or more second errors in the data, a type of the one or more second errors, address information associated with the one or more second errors, or any combination thereof.

13. The memory system of claim 1, wherein the processing circuitry is further configured to cause the memory system to:
perform the error check operation in accordance with a cyclic redundancy check algorithm.

14. A method by a memory system, comprising:
receiving, via an interface coupled with one or more memory devices of the memory system, data and redundancy information associated with the data;
performing an error check operation on the data in accordance with the redundancy information, wherein the error check operation checks for one or more errors in the data due to transfer of the data via the interface;
determining whether to perform error correction based at least in part on the error check operation; and
writing, to the one or more memory devices, the data and parity information associated with the data based at least in part on determining whether to perform the error correction.

15. The method of claim 14, further comprising:
transmitting, via the interface and based at least in part on determining to perform the error correction, a retransmission request, wherein the retransmission request facilitates the error correction, and wherein determining to perform the error correction is based at least in part on identification, during the error check operation, of at least one error in the data due to the transfer of the data via the interface;
receiving, via the interface in response to the retransmission request, a retransmission of the data and the redundancy information; and
performing a second error check operation on the data in accordance with the redundancy information and the retransmission.

16. The method of claim 15, further comprising:
generating the parity information associated with the data based at least in part on identification, during the second error check operation, of an absence of errors in the data, wherein writing the data and the parity information associated with the data is based at least in part on generation of the parity information.

17. The method of claim 16, further comprising:
generating second redundancy information associated with the data based at least in part on identification, during the second error check operation, of the absence of errors in the data; and
writing, with the data and the parity information, the second redundancy information to the one or more memory devices.

18. The method of claim 15, further comprising:
transmitting, via the interface, a second retransmission request based at least in part on identification, during the second error check operation, of at least one error in the data due to the transfer of the data via the interface, the method further comprising:
transmitting one or more retransmission requests until the data is received, via the interface, with an absence of errors.

19. The method of claim 14, further comprising:
performing, using the redundancy information associated with the data, an error correction operation to correct the one or more errors in the data, wherein performing the error correction operation is based at least in part on determining to perform the error correction in accordance with identifying, during the error check operation, of the one or more errors in the data, wherein generating the parity information is based at least in part on performing the error correction operation.

20. The method of claim 14, further comprising:
generating the parity information associated with the data based at least in part on determining to refrain from performing the error correction in accordance with identification, during the error check operation, of an absence of errors in the data, wherein writing the data and the parity information associated with the data is based at least in part on generation of the parity information.

21. The method of claim 14, further comprising:
generating second redundancy information associated with the data; and
writing, with the data and the parity information, the second redundancy information to the one or more memory devices, wherein the second redundancy information is configured for checking which memory device, of the one or more memory devices, comprises an error.

22. The method of claim 14, further comprising:
receiving a request to read the data from the one or more memory devices;
reading, from the one or more memory devices in response to the request, the data, the parity information associated with the data, and second redundancy information associated with the data;
performing a second error check operation on the data based at least in part on reading the data and in accordance with the second redundancy information, wherein the second error check operation identifies a memory device from among the one or more memory devices that comprises one or more second errors; and
performing an error check and correction operation on the data associated with the memory device identified by the second error check operation and in accordance with the parity information, wherein the error check and correction operation corrects the one or more second errors in the data in accordance with the parity information.

23. A non-transitory computer-readable medium storing code, the code comprising instructions executable by one or more processors of a memory system to:
receive, via an interface coupled with one or more memory devices of the memory system, data and redundancy information associated with the data;
perform an error check operation on the data in accordance with the redundancy information, wherein the error check operation checks for one or more errors in the data due to transfer of the data via the interface;
determine whether to perform error correction based at least in part on the error check operation; and
write, to the one or more memory devices, the data and parity information associated with the data based at least in part on determining whether to perform the error correction.

24. The non-transitory computer-readable medium of claim 23, wherein the instructions are further executable by the one or more processors to:
transmit, via the interface and based at least in part on determining to perform the error correction, a retransmission request, wherein the retransmission request facilitates the error correction, and wherein determining to perform the error correction is based at least in part on identification, during the error check operation, of at least one error in the data due to the transfer of the data via the interface;
receive, via the interface in response to the retransmission request, a retransmission of the data and the redundancy information; and
perform a second error check operation on the data in accordance with the redundancy information and the retransmission.
